(19) United States
(12) Patent Application Publication
(10) Pub. No.: US 2022/0302450 A1
(43) Pub. Date: Sep. 22, 2022

(54) NEGATIVE ELECTRODE FOR RECHARGEABLE LITHIUM BATTERY AND RECHARGEABLE LITHIUM BATTERY COMPRISING NEGATIVE ELECTRODE

(71) Applicant: SAMSUNG SDI CO., LTD., Yongin-si (KR)

(72) Inventor: Eunji KANG, Yongin-si (KR)

(21) Appl. No.: 17/689,836

(22) Filed: Mar. 8, 2022

(30) Foreign Application Priority Data
Mar. 9, 2021 (KR) 10-2021-0030948

(51) Int. Cl. H01M 4/583; H01M 10/0525; H01M 4/36

(52) U.S. Cl. CPC H01M 4/583; H01M 10/0525; H01M 4/366; H01M 2004/027

(57) ABSTRACT

A negative electrode for a rechargeable lithium battery which includes a current collector, a first negative electrode active material layer on one surface or both surfaces of the current collector; a second negative electrode active material layer on the first negative electrode active material layer is provided. The first negative electrode active material layer includes a first negative electrode active material, the first negative electrode active material includes graphite of single particles, the second negative electrode active material layer includes a second negative electrode active material, the second negative electrode active material includes graphite including secondary particles in which a plurality of primary particles are agglomerated (assembled), and an average particle diameter of the second negative electrode active material is smaller than an average particle diameter of the first negative electrode active material.

### CROSS-REFERENCE TO RELATED APPLICATION

This application claims priority to and the benefit of Korean Patent Application No. 10-2021-0030948 filed in the Korean Intellectual Property Office on Mar. 9, 2021, the entire content of which is hereby incorporated herein by reference.

### BACKGROUND

### 1. Field

A negative electrode for a rechargeable lithium battery and a rechargeable lithium battery including the same are disclosed.

### 2. Description of the Related Art

In recent years, because electronic devices utilizing batteries such as mobile phones, notebook computers, tablet PCs, electric vehicles, and/or the like are rapidly spreading, a demand for secondary batteries, which are small and lightweight but have relatively high capacity, also is rapidly increasing. For example, rechargeable lithium batteries are lightweight and have a high energy density and thus draw attention as a driving power source for portable devices. Accordingly, research and development for improving performance of the rechargeable lithium batteries are being actively conducted.

A rechargeable lithium battery includes a positive electrode including an active material intercalating and deintercalating lithium ions, a negative electrode, and an electrolyte solution, wherein the lithium ions are intercalated/deintercalated at the positive and negative electrodes and thus generate electrical energy through oxidation and reduction.

For a positive electrode active material of the rechargeable lithium battery, a transition metal compound such as lithium cobalt oxide, lithium nickel oxide, or lithium manganese oxide is primarily utilized. For a negative electrode active material, a crystalline carbon material such as natural graphite or artificial graphite, or an amorphous carbon material is utilized.

### SUMMARY

In an embodiment of the present disclosure, a negative electrode for a rechargeable lithium battery includes a current collector; a first negative electrode active material layer on one or both surfaces of the current collector; and a second negative electrode active material layer on the first negative electrode active material layer, wherein the first negative electrode active material layer includes a first negative electrode active material, the first negative electrode active material includes graphite having a single particle shape, the second negative electrode active material layer includes a second negative electrode active material, the second negative electrode active material includes graphite including secondary particles in which a plurality of primary particles are agglomerated (assembled), and an average particle diameter of the second negative electrode active material is smaller than an average particle diameter of the first negative electrode active material.

In the first negative electrode active material, the single particles may have an average particle diameter of greater than about 15 μm.

In the second negative electrode active material, the secondary particles may have an average particle diameter of less than or equal to about 15 μm.

In the second negative electrode active material, the primary particles may have an average particle diameter of about 1 μm to about 10 μm.

A ratio of the particle diameter of the secondary particles of the second negative electrode active material to the particle diameter of the single particles of the first negative electrode active material may be about 0.1 to about 0.9.

A specific surface area of the second negative electrode active material may be smaller than that of the first negative electrode active material. For example, the first negative electrode active material may have a specific surface area of greater than about 1.5 m²/g, and the second negative electrode active material may have a specific surface area of less than or equal to about 1.5 m²/g.

A pellet density of the second negative electrode active material may be smaller than that of the first negative electrode active material. For example, the first negative electrode active material may have a pellet density of greater than about 1.6 g/cc, and the second negative electrode active material may have a pellet density of less than or equal to about 1.6 g/cc.

At least one of the first negative electrode active material or the second negative electrode active material may be coated with amorphous carbon.

In the negative electrode, a weight ratio of the first negative electrode active material to the second negative electrode active material may be about 10:90 to about 50:50.

A ratio of the thickness of the first negative electrode active material layer to the thickness of the second negative electrode active material layer may be about 10:90 to about 40:60.

In another embodiment, a rechargeable lithium battery including the aforementioned negative electrode for a rechargeable lithium battery is provided.

The negative electrode for a rechargeable lithium battery may effectively suppress or reduce precipitation of lithium metal during high-rate charging at a low temperature, and concurrently exhibit high capacity and high efficiency characteristics.

### BRIEF DESCRIPTION OF THE DRAWINGS

FIG. 1 is a cross-sectional view schematically showing a negative electrode for a rechargeable lithium battery according to an embodiment.

FIG. 2 schematically shows a rechargeable lithium battery according to an embodiment.

### DETAILED DESCRIPTION

Hereinafter, specific embodiments will be described in more detail so that those of ordinary skill in the art can easily implement them. However, this disclosure may be embodied in many different forms and is not construed as limited to the example embodiments set forth herein.

The terminology utilized herein is utilized to describe embodiments only, and is not intended to limit the present disclosure. The singular expression includes the plural expression unless the context clearly dictates otherwise.

As utilized herein, “a combination thereof” refers to a mixture, a laminate, a composite, a copolymer, an alloy, a blend, a reaction product, and/or the like of constituents. Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout, and duplicative descriptions thereof may not be provided in the disclosure. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In some embodiments, “layer” herein includes not only a shape formed on the whole surface when viewed from a plan view, but also a shape formed on a partial surface. In some embodiments, the average particle diameter may be measured by a method generally available to those skilled in the art, for example, by a particle size analyzer, or by a transmission electron micrograph or a scanning electron micrograph. In some embodiments, it is possible to obtain an average particle diameter value by utilizing a dynamic light scattering method, performing data analysis, counting the number of particles for each particle size range, and calculating the average particle diameter from these results. Unless otherwise defined, the average particle diameter may refer to the diameter (D50) of particles having a cumulative volume of 50 volume % in the particle size distribution.

### Negative Electrode

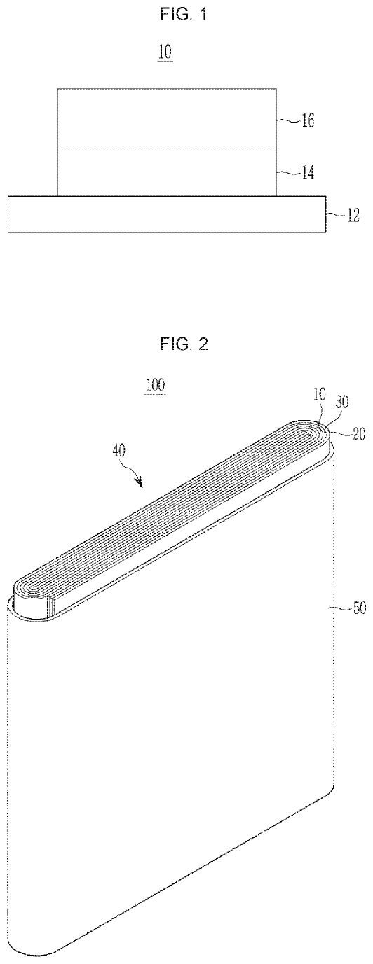

Hereinafter, a negative electrode for a rechargeable lithium battery according to an embodiment will be described with reference to FIG. 1. FIG. 1 is a cross-sectional view schematically illustrating a negative electrode for a rechargeable lithium battery according to an embodiment. Referring to FIG. 1, a negative electrode for a rechargeable lithium battery 10 includes a current collector 12, a first negative electrode active material layer 14 on one or both surfaces of the current collector, and a second negative electrode active material layer 16 on the first negative electrode active material layer 14. The first negative electrode active material layer 14 includes a first negative electrode active material and the first negative electrode active material includes graphite of single particles. The second negative electrode active material layer 16 includes a second negative electrode active material and the second negative electrode active material includes graphite including secondary particles in which a plurality of primary particles are agglomerated (assembled). Herein, an average particle diameter of the second negative electrode active material is smaller than that of the first negative electrode active material. This may indicate that the particle diameter of the secondary particles of the second negative electrode active material is smaller than the average particle diameter of the single particles of the first negative electrode active material.

In the negative electrode of a rechargeable lithium battery, during high-rate charging at a low temperature, lithium metal precipitation (Li-plating) may occur on the surface of the electrode plate. Such precipitation of lithium metal accelerates a capacity loss of the rechargeable lithium battery, and consequently reduces the cycle-life. In an embodiment, because the second negative electrode active material layer at the surface side includes the second negative electrode active material including graphite including the secondary particles in which a plurality of the primary particles is agglomerated (assembled) and having a smaller average particle diameter, precipitation of lithium metal may be effectively suppressed or reduced during the high-rate charging at a low temperature, improving resistance and charge/discharge efficiency and realizing a high output. In some embodiments, because the first negative electrode active material layer at the current collector includes the first negative electrode active material including graphite of single particles and having a larger average particle diameter, a bonding force between electrode plate and substrate may be improved, mixture density and charge/discharge efficiency may be improved, and high capacity may be realized.

If the first negative electrode active material and the second negative electrode active material are simply mixed and if the first negative electrode active material layer and the second negative electrode active material layer are disposed in the opposite order, effects of each active material are substantially halved. The negative electrode for a rechargeable lithium battery according to an embodiment may effectively suppress or reduce lithium precipitation during the high-rate charging at a low temperature and concurrently (e.g., simultaneously), improve a bonding force of an electrode plate and exhibit high capacity and high efficiency characteristics by disposing (or arranging) the first negative electrode active material layer including the first negative electrode active material on a current collector and sequentially, the second negative electrode active material layer including the second negative electrode active material on the first negative electrode active material layer.

The first negative electrode active material includes single particle-type or kind graphite and has a larger average particle diameter than the second negative electrode active material and concurrently (e.g., simultaneously), a higher specific surface area and pellet density. This first negative electrode active material may exhibit excellent or suitable density characteristics and an excellent or suitable bonding force of an electrode plate and realize high capacity.

In the first negative electrode active material, the single particle may have an average particle diameter of greater than about 15 μm, and, for example, greater than or equal to about 15.5 μm, greater than or equal to about 16 μm, greater than or equal to about 17 μm, greater than or equal to about 18 μm, and less than or equal to about 30 μm, less than or equal to about 25 μm, or less than or equal to about 20 μm. If the single particle-type or kind graphite having an average particle diameter within the above ranges is included in the first negative electrode active material layer, the mixture density and bonding force of an electrode plate may be improved, and high capacity may be realized.

The second negative electrode active material includes secondary particle-type or kind graphite and may have a smaller average particle diameter than the first negative electrode active material and a smaller specific surface area and lower pellet density. This second negative electrode active material may effectively suppress or reduce precipitation of lithium metal from the surface side, lower resistance, improve battery performance at a low temperature such as charge/discharge efficiency and/or the like, and realize high power characteristics.

In the second negative electrode active material, the secondary particles may have an average particle diameter of less than or equal to about 15 μm. For example, the secondary particles may have a particle diameter of less than or equal to about 15 μm, less than or equal to about 14 μm, less than or equal to about 13 μm, less than or equal to about 12 μm, or less than or equal to about 11 μm and greater than or equal to about 1 μm, greater than or equal to about 2 μm, greater than or equal to about 3 μm, greater than or equal to about 5 μm, greater than or equal to about 7 μm, or greater than or equal to about 9 μm. In the second negative electrode active material, the primary particles constituting the secondary particles may have an average particle diameter of about 1 μm to about 10 μm, and, for example, about 2 μm to about 10 μm, about 3 μm to about 9 μm, about 4 μm to about 9 μm, or about 6 μm to about 9 μm. If graphite having the primary and secondary particle diameters is included in the second negative electrode active material layer, low temperature characteristics (precipitation of lithium metal, charge/discharge efficiency, and/or the like) and output characteristics may be improved.

The secondary particles may be prepared, for example, in the following manufacturing method. A pulverization process of pulverizing a graphite raw material having a particle diameter of about 80 μm or more into primary particles is performed. Herein, the graphite raw material may be pulverized into the primary particles by applying an airflow pulverization method. The airflow pulverization may pulverize the graphite raw material at room temperature with an airflow of about 5 kg/cm² to about 20 kg/cm². Accordingly, the prepared primary particles are agglomerated (assembled) into secondary particles through a spheroidization process utilizing spheroidization equipment.

A ratio of the particle diameter of the secondary particles of the second negative electrode active material to the particle diameter of the single particles of the first negative electrode active material may be about 0.1 to about 0.9, and, for example, about 0.2 to about 0.9, about 0.3 to about 0.8, about 0.4 to about 0.8, or about 0.5 to about 0.7. If the particle diameter ratio is within these ranges, high capacity and high power characteristics may be realized, and concurrently (e.g., simultaneously), mixture density, a bonding force to a substrate, and charge/discharge efficiency may be improved, and the problem of lithium metal precipitation may be effectively suppressed or reduced.

Herein, the particle diameters of the single particles, the primary particles, and the secondary particles may be an average particle diameter. Herein, the average particle diameter may be a particle diameter (D50) at about 50 volume % in a cumulative size-distribution curve, which may be measured by putting a plurality of particles into a particle size analyzer.

A specific surface area (BET) of the second negative electrode active material may be smaller than a specific surface area (BET) of the first negative electrode active material.

For example, the first negative electrode active material may have a specific surface area of greater than about 1.5 m²/g, for example, greater than or equal to about 1.6 m²/g, greater than or equal to about 1.7 m²/g, greater than or equal to about 1.8 m²/g, greater than or equal to about 1.9 m²/g, or greater than or equal to about 2.0 m²/g and less than or equal to about 2.9 m²/g, less than or equal to about 2.5 m²/g, less than or equal to about 2.3 m²/g, or less than or equal to about 2.1 m²/g. The first negative electrode active material having a specific surface area within the ranges may exhibit excellent or suitable density characteristics and realize high capacity.

The second negative electrode active material may have a specific surface area of less than or equal to about 1.5 m²/g, for example, less than or equal to about 1.5 m²/g, less than or equal to about 1.4 m²/g, less than or equal to about 1.3 m²/g, less than or equal to about 1.2 m²/g, or less than or equal to about 1.1 m²/g and greater than or equal to about 1.0 m²/g, greater than or equal to about 1.2 m²/g, or greater than or equal to about 1.3 m²/g. The second negative electrode active material having a specific surface area within the ranges may improve battery resistance and realize high power characteristics.

A pellet density of the first negative electrode active material may be greater than that of the second negative electrode active material.

For example, the first negative electrode active material may have a pellet density of greater than about 1.6 g/cc, for example, greater than or equal to about 1.65 g/cc, greater than or equal to about 1.7 g/cc, greater than or equal to about 1.75 g/cc and less than or equal to about 2.0 g/cc or less than or equal to about 1.9 g/cc. The first negative electrode active material having pellet density within these ranges may exhibit excellent or suitable density characteristics and realize high capacity.

The second negative electrode active material may have a pellet density of less than or equal to about 1.6 g/cc, for example, less than or equal to about 1.55 g/cc or less than or equal to about 1.53 g/cc and greater than or equal to about 1.2 g/cc, greater than or equal to about 1.3 g/cc, or greater than or equal to about 1.4 g/cc. The second negative electrode active material having a pellet density within these ranges may improve battery resistance and realize high power characteristics.

At least one of the first negative electrode active material or the second negative electrode active material may be coated with amorphous carbon. For example, the first negative electrode active material or the second negative electrode active material may be coated with amorphous carbon, or both the first negative electrode active material and the second negative electrode active material may be coated with amorphous carbon. If this amorphous carbon coating is performed, a specific surface area may be improved.

In the negative electrode, a weight ratio of the first negative electrode active material to the second negative electrode active material may be about 10:90 to about 90:10, and, for example, about 20:80 to about 80:20, or about 30:70 to about 70:30. In an embodiment, the weight of the second negative electrode active material in the negative electrode may be higher than that of the first negative electrode active material, and thus the weight ratio may be about 10:90 to about 45:55, about 10:90 to about 40:60, about 10:90 to about 30:70, or about 10:90 to about 20:80. In this embodiment, the negative electrode may improve charging and discharging efficiency while implementing high capacity and high power characteristics, and further solve lithium metal precipitation problems.

A ratio of the thickness of the first negative electrode active material layer to the thickness of the second negative electrode active material layer may be about 10:90 to about 90:10, and for example about 20:80 to about 80:20, or about 30:70 to about 70:30. In an embodiment, the thickness of the second negative electrode active material layer may be greater than that of the first negative electrode active material layer, and thus the ratio of the thicknesses may be about 10:90 to about 45:55, about 10:90 to about 40:60, about 10:90 to about 30:70, or about 10:90 to about 20:80. In this embodiment, the negative electrode may improve charging and discharging efficiency while implementing high capacity and high power characteristics, and further solve lithium metal precipitation problems.

In the first negative electrode active material layer and the second negative electrode active material layer, each content (e.g., amount) of the first negative electrode active material and the second negative electrode active material may be about 90 wt % to about 99 wt %, and for example about 95 wt % to about 99 wt % based on each 100 wt % of the first negative electrode active material layer and the second negative electrode active material layer.

The first negative electrode active material layer may include a binder together with the first negative electrode active material, and may optionally further include a conductive material. The second negative electrode active material layer includes a binder together with the second negative electrode active material, and may optionally further include a conductive material.

When the first negative electrode active material layer and/or the second negative electrode active material layer include a binder, the content (e.g., amount) of the binder may be about 1 wt % to about 5 wt % based on each 100 wt % of the first negative electrode active material layer and the second negative electrode active material layer. In some embodiments, when the conductive material is further included, the content (e.g., amount) of the conductive material may be about 1 wt % to about 5 wt % based on each 100 wt % of the first negative electrode active material layer and the second negative electrode active material layer. The first negative electrode active material layer and/or the second negative electrode active material layer may (may each) include about 90 wt % to about 98 wt % of the negative electrode active material, about 1 wt % to about 5 wt % of the binder, and about 1 wt % to about 5 wt % of the conductive material, respectively.

The binder serves to adhere the negative electrode active material particles to each other and also to adhere the negative electrode active material to the current collector. The binder may be a non-aqueous binder, an aqueous binder, or a combination thereof.

The non-aqueous binder may include an ethylenepropylene copolymer, polyacrylonitrile, polystyrene, polyvinylchloride, carboxylated polyvinylchloride, polyvinyl fluoride, polyurethane, polytetrafluoroethylene, polyvinylidene fluoride, polyethylene, polypropylene, polyacrylamide, polyamide, polyamideimide, polyimide, or a combination thereof.

The aqueous binder may be a styrene-butadiene rubber (SBR), an acrylated styrene-butadiene rubber (ABR), an acrylonitrile-butadiene rubber, an acrylic rubber, a butyl rubber, a fluorine rubber, an ethylene oxide-containing polymer, polyvinylpyrrolidone, polypropylene, polyepichlorohydrine, polyphosphazene, an ethylenepropylenediene copolymer, polyvinyl pyridine, chlorosulfonatedpolyethylene, latex, a polyester resin, an acrylic resin, a phenolic resin, an epoxy resin, polyvinyl alcohol, or a combination thereof.

If an aqueous binder is utilized as the negative electrode binder, a cellulose-based compound capable of imparting viscosity may be further included as a thickener. For the cellulose-based compound, one or more of carboxymethyl cellulose (CMC), hydroxypropylmethyl cellulose, methyl cellulose, or alkali metal salts thereof may be mixed and utilized. For the alkali metal, Na, K, or Li may be utilized. The amount of the thickener utilized may be about 0.1 parts by weight to about 3 parts by weight based on 100 parts by weight of the negative active material.

The conductive material may be included to provide electrode conductivity. Any suitable electrically conductive material may be utilized as a conductive material unless it causes a chemical change. Examples of the conductive material include a carbon-based material such as natural graphite, artificial graphite, carbon black, acetylene black, ketjen black, a carbon fiber, a carbon nanofiber, a carbon nanotube, and/or the like; a metal-based material of a metal powder or a metal fiber of copper, nickel, aluminum silver, and/or the like; a conductive polymer such as a polyphenylene derivative; and/or one or more mixtures thereof.

The current collector may include at least one selected from a copper foil, a nickel foil, a stainless-steel foil, a titanium foil, a nickel foam, a copper foam, a polymer substrate coated with a conductive metal, and combinations thereof.

In another embodiment, a rechargeable lithium battery including the aforementioned negative electrode for a rechargeable lithium battery is provided. The rechargeable lithium battery may include a positive electrode and an electrolyte in addition to the aforementioned negative electrode.

### Positive Electrode

The positive electrode may include a current collector and a positive electrode active material layer formed on the current collector.

The positive electrode active material may include lithiated intercalation compounds that reversibly intercalate and deintercalate lithium ions. For example, one or more composite oxides of a metal selected from cobalt, manganese, nickel, and a combination thereof, and lithium may be utilized. For example, a compound represented by any one of the following chemical formulas may be utilized. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.05, 0<α<2); LiₐNi_{1-b-c}Co_{b}X_{c}O_{2-α}T₂ (0.90≤a≤1.8, 0≤b≤0.5, 0≤c≤0.05, 0<α<2); LiₐNi_{1-b-c}Mn_{b}X_{c}D_{α} (0.90≤a≤1.8, 0≤b≤0.5, 0≤c≤0.05, 0<α≤2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂ (0.90≤a≤1.8, 0≤b≤0.5, 0≤c≤0.05, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0≤e≤0.1); LiₐNi_{b}CO_{c}Mn_{d}GₑO₂ (0.90≤a≤1.8, 0≤b≤0.9, 0≤c≤0.5, 0≤d≤0.5, 0≤e≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8).

In the chemical formulae, A is at least one selected from Ni, Co, Mn, and combinations thereof; X is at least one selected from Al, Ni, Co, Mn, Cr, Fe, Mg, Sr, V, a rare earth element, and combinations thereof; D is at least one selected from O, F, S, P, and combinations thereof; E is at least one selected from Co, Mn, and combinations thereof; T is at least one selected from F, S, P, and combinations thereof; G is at least one selected from Al, Cr, Mn, Fe, Mg, La, Ce, Sr, V, and combinations thereof; Q is at least one selected from Ti, Mo, Mn, and combinations thereof; Z is at least one selected from Cr, V, Fe, Sc, Y, and combinations thereof; and J is at least one selected from V, Cr, Mn, Co, Ni, Cu, and combinations thereof. The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by utilizing these elements in the compound. For example, the method may include any suitable coating method (e.g., spray coating, dipping, etc.). Possible coating methods should be apparent to one of ordinary skill in the art upon reviewing the present disclosure.

In the positive electrode, a content (e.g., amount) of the positive electrode active material may be about 90 wt % to about 98 wt % based on the total weight of the positive electrode active material layer.

In an embodiment, the positive electrode active material layer may further include a binder and a conductive material. In this embodiment, each content (e.g., amount) of the binder and the conductive material may be about 1 wt % to about 5 wt % based on the total weight of the positive electrode active material layer.

The binder serves to adhere the positive electrode active material particles to each other and also to adhere the positive electrode active material to the current collector. Examples thereof may be polyvinyl alcohol, carboxylmethyl cellulose, hydroxypropyl cellulose, diacetyl cellulose, polyvinylchloide, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but are not limited thereto.

The conductive material is utilized to impart conductivity to the electrode, and any suitable material may be utilized as long as it does not cause chemical change (e.g., substantially without causing an undesirable chemical change) in the battery to be configured and is an electron conductive material. Examples of the conductive material may include a carbon-based material such as natural graphite, artificial graphite, carbon black, acetylene black, ketjen black, a carbon fiber, a carbon nanofiber, a carbon nanotube, and/or the like; a metal-based material of a metal powder or a metal fiber, and/or the like of copper, nickel, aluminum silver, and/or the like; a conductive polymer such as a polyphenylene derivative; and/or one or more mixtures thereof.

The current collector may include Al, but is not limited thereto.

### Rechargeable Lithium Battery

The electrolyte solution includes a non-aqueous organic solvent and a lithium salt.

The non-aqueous organic solvent serves as a medium for transmitting ions taking part in the electrochemical reaction of a battery.

The non-aqueous organic solvent may be a carbonate-based, ester-based, ether-based, ketone-based, or alcohol-based solvent, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, t-butylacetate, methylpropionate, ethylpropionate, decanolide, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like. In some embodiments, the ketone-based solvent may be cyclohexanone, and/or the like. In some embodiments, the alcohol-based solvent may be ethyl alcohol, isopropyl alcohol, etc. and the aprotic solvent may be nitriles such as R—CN, where R is a C2 to C20 linear, branched, or cyclic hydrocarbon group and may include a double bond, an aromatic ring, or an ether bond, amides such as dimethylformamide, dioxolanes such as 1,3-dioxolane, sulfolanes, and/or the like.

The organic solvent may be utilized alone or in a mixture. When the organic solvent is utilized in a mixture, the mixture ratio may be controlled or selected in accordance with a desirable (suitable) battery performance.

In some embodiments, a mixture of a cyclic carbonate and a chain carbonate may be utilized for the carbonate-based solvent. In these embodiments, if the cyclic carbonate and the chain carbonate are mixed in a volume ratio of about 1:1 to about 1:9, the electrolyte may exhibit excellent or suitable performance.

The organic solvent may further include an aromatic hydrocarbon-based organic solvent in addition to the carbonate-based solvent. In this embodiment, the carbonate-based solvent and the aromatic hydrocarbon-based organic solvent may be mixed in a volume ratio of about 1:1 to about 30:1.

For the aromatic hydrocarbon-based organic solvent, an aromatic hydrocarbon-based compound represented by Chemical Formula 1 may be utilized.

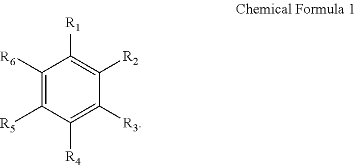

In Chemical Formula 1, R₁ to R₆ may each independently be the same or different and are hydrogen, a halogen, a C1 to C10 alkyl group, a C1 to C10 haloalkyl group, or a combination thereof.

Specific examples of the aromatic hydrocarbon-based organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trchlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-tichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or one or more combinations thereof.

The electrolyte may further include vinylene carbonate or an ethylene carbonate-based compound of Chemical Formula 2 in order to improve cycle-life of a battery.

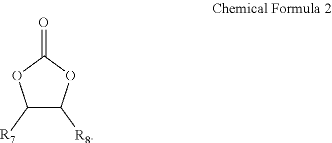

In Chemical Formula 2, R₇ and R₈ may each independently be the same or different, and hydrogen, a halogen, a cyano group (CN), a nitro group (NO₂), or fluorinated C1 to C5 alkyl group, provided that at least one of R₇ or R₈ is a halogen, a cyano group (CN), a nitro group (NO₂), or fluorinated C1 to C5 alkyl group and both of R₇ and R₈ are not hydrogen (i.e., one (only one) of R₇ and R₈ is a hydrogen).

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, and/or fluoroethylene carbonate. The amount of the additive for improving cycle-life may be utilized within an appropriate or suitable range.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide): LiFSI), LiC₄F₉SO₃, LiClO₄, LiAlO₂, LiAlC₁₄, LiPO₂F₂, LiN(CₓF₂ₓ₊₁SO₂)(C_{y}F_{2y+1}SO₂), wherein x and y are natural numbers, for example, an integer in a range of 1 to 20, lithium difluoro(bisoxolato) phosphate, LiCl, LiI, LiB(C₂O₄)₂ (lithium bis(oxalato) borate, LiBOB), and/or lithium difluoro(oxalato)borate (LiDFOB). The lithium salt may be utilized at a concentration from about 0.1 M to about 2.0 M. If the lithium salt is included at the above concentration range, an electrolyte may have excellent or suitable performance and lithium ion mobility due to optimal or suitable electrolyte conductivity and viscosity.

The rechargeable lithium battery may further include a separator between the negative electrode and the positive electrode, depending on a type or kind of the battery. Examples of a suitable separator material may include polyethylene, polypropylene, and/or polyvinylidene fluoride, and multi-layers thereof such as a polyethylene/polypropylene double-layered separator, a polyethylene/polypropylene/polyethylene triple-layered separator, and/or a polypropylene/polyethylene/polypropylene triple-layered separator.

FIG. 2 is a schematic view of a rechargeable lithium battery according to an embodiment. The rechargeable lithium battery according to an embodiment is illustrated as a prismatic battery but is not limited thereto and may include suitably shaped batteries such as a cylindrical battery, a pouch battery, and/or the like.

Referring to FIG. 2, a rechargeable lithium battery 100 according to an embodiment includes an electrode assembly 40 manufactured by winding a separator 30 interposed between a positive electrode 10 and a negative electrode 20, and a case 50 housing the electrode assembly 40. An electrolyte may be impregnated in the positive electrode 10, the negative electrode 20, and the separator 30. Rechargeable lithium batteries may be classified as lithium ion batteries, lithium ion polymer batteries, or lithium polymer batteries according to the presence of a separator and the type or kind of electrolyte utilized therein. The rechargeable lithium batteries may have a variety of shapes and sizes, and include cylindrical, prismatic, coin, or pouch-type or kind batteries, and may be thin film batteries or may be rather bulky in size. Structures and manufacturing methods for lithium ion batteries pertaining to aspects of embodiments of the present disclosure should be apparent to one of ordinary skill in the art upon reviewing the present disclosure.

The rechargeable lithium battery according to an embodiment may be utilized in an electric vehicle (EV), a hybrid electric vehicle such as a plug-in hybrid electric vehicle (PHEV), and/or a portable electronic device because it implements a high capacity and has an excellent or suitable storage stability, cycle-life characteristics, and high rate characteristics at high temperatures.

Hereinafter, examples of the present disclosure and comparative examples are described. It is to be understood, however, that the examples are for the purpose of illustration and are not to be construed as limiting the present disclosure.

Manufacture of Negative Electrode for Rechargeable Lithium Battery

### Example 1

97.5 wt % of single particle-type or kind graphite having an average particle diameter (D50) of 16 μm, a true density of 2.23 g/cm³, a specific surface area of 1.9 m²/g, and a pellet density (@2 ton) of 1.76 g/cc as a first negative electrode active material, 1.5 wt % of styrene-butadiene rubber (SBR) as a binder, and 1.0 wt % of carboxymethyl cellulose (CMC) were added to distilled water, preparing slurry for a first active material layer.

97.5 wt % of secondary particle-type or kind graphite having an average particle diameter (D50) of 11 μm, a true density of 2.23 g/cm³, a specific surface area of 1.5 m²/g, and a pellet density (@2 ton) of 1.51 g/cc as a second negative electrode active material, 1.5 wt % of SBR as a binder, and 1.0 wt % of CMC were added to distilled water, preparing slurry for a second active material layer.

The slurry for a first active material layer was coated on a 8 to 10 μm-thick copper thin film as a negative electrode current collector and dried, forming a 14 to 16 μm-thick first active material layer on the current collector. The slurry for a second active material layer was coated on the first active material layer and dried, forming a double active material layer with a final thickness of 80 to 85 μm on the current collector (herein, the second active material layer had a thickness of about 66 to 69 μm). The double active material layer on the current collector was compressed to have an electrode density of 1.65 g/c, manufacturing a negative electrode.

### Comparative Example 1

29.3 wt % of the first negative electrode active material utilized in Example 1, 68.3 wt % of the second negative electrode active material utilized in Example 1, 1.5 wt % of SBR as a binder, and 1.0 wt % of CMC were added to distilled water, preparing slurry for an active material layer according to Comparative Example 1. The slurry for an active material layer was coated on a 8 to 10 μm-thick copper thin film as a negative electrode current collector and dried, forming an 80 to 85 μm-thick active material layer on the current collector according to Comparative Example 1. The active material layer on the current collector was compressed to have an electrode density of 1.65 g/cc, manufacturing a negative electrode.

### Comparative Example 2

A double active material layer was formed to have a final thickness of 80 to 85 μm on a current collector in substantially the same manner as Example 1 except that the first active material layer and the second active material layer were disposed in the opposite order. The double active material layer on the current collector was compressed to have an electrode density of 1.65 g/cc, manufacturing a negative electrode.

### Comparative Example 3

97.5 wt % of the first negative electrode active material utilized in Example 1, 1.5 wt % of SBR as a binder, and 1.0 wt % of CMC were added to distilled water, preparing slurry for a first active material layer.

97.5 wt % of secondary particle-type or kind graphite having an average particle diameter (D50) of about 16 μm as a third negative electrode active material, 1.5 wt % of SBR as a binder, and 1.0 wt % of CMC were added to distilled water, preparing slurry for a third active material layer.

The slurry for a first active material layer was coated on a 8 to 10 μm-thick copper thin film as a negative electrode current collector and dried, forming a 40 to 43 μm-thick first active material layer on the current collector. The slurry for a third active material layer was coated on the first active material layer and then, dried, forming a double active material layer having a final thickness of 80 to 85 μm on the current collector. The double active material layer on the current collector was compressed to have electrode density of 1.65 g/cc, manufacturing a negative electrode.

### Manufacture of Battery Cells

The negative electrodes according to Example 1 and Comparative Examples 1 to 3 were respectively utilized with a lithium metal counter electrode and an electrolyte solution, manufacturing half-cells.

A separator of a porous polyethylene (PE) film (a thickness: about 16 μm) was disposed between negative electrode and the lithium metal counter electrode, and an electrolyte solution was injected thereinto, manufacturing coin cells. Herein, the electrolyte solution was prepared by utilizing a mixed solvent of a cyclic carbonate-based material and a propionate-based material in a weight ratio of 1:3 and dissolving 1.3 M of LiPF₆ therein.

### Evaluation 1. Efficiency of Battery Cells

Each of the cells respectively including the negative electrodes according to Example 1 and Comparative Examples 1 to 3 was evaluated with respect to capacity. The cells were once charged and discharged in a voltage range of −0.5 V or −0.6 V to 1.0 V at a current (2 C-rate) at a low temperature (0° C.), which was twice the value corresponding to actual capacity of each of the cells, to measure charge capacity and discharge capacity and to evaluate a ratio (CE) of the discharge capacity to the charge capacity, and the results are shown in Table 1.

### Evaluation 2. Precipitation Amount of Lithium Metal

After charging the cells at a low temperature (0° C.), based on a high voltage stabilization period of a discharge profile, a precipitation amount of lithium metal (mg) was calculated. This voltage stabilization period corresponds to a stripping process of lithium precipitated from the surface of graphite during the charge. A stripping amount of the precipitated lithium was obtained from Dv/dQ peak and then, quantified, obtaining the amount of the precipitated lithium metal. Herein, a calculation method and/or the like may be found in, for example, Journal of Power Sources, Volume 254, 15 May 2014, Pages 80 to 87, the entire content of which is hereby incorporated herein by reference.

TABLE 1

| | | | | Precipitation |
|---|---|---|---|---|
| | Charge | Discharge | | amount of |
| Negative electrode | capacity | capacity | CE | lithium |
| (SOC 60) | (mAh/g) | (mAh/g) | (%) | metal (mg) |
| Example 1 | 207 | 197 | 95 | 0.7 |
| Comparative Example 1 | 210 | 197 | 94 | 0.9 |
| Comparative Example 2 | 203 | 156 | 77 | 3.3 |

TABLE 2

| | | | | Precipitation |
|---|---|---|---|---|
| | Charge | Discharge | | amount of |
| Negative electrode | capacity | capacity | CE | lithium |
| (SOC 120) | (mAh/g) | (mAh/g) | (%) | metal (mg) |
| Example 1 | 417 | 337 | 81 | 5.8 |
| Comparative Example 1 | 418 | 330 | 79 | 6.3 |
| Comparative Example 2 | 420 | 289 | 69 | 9.5 |
| Comparative Example 3 | 420 | 335 | 80 | 6.0 |

Referring to Table 1, at a charge rate (SOC 60) of 60%, Comparative Example 2 exhibited low discharge capacity, greatly deteriorated charge/discharge efficiency, and a relatively large precipitation amount of lithium metal. In contrast, Example 1 exhibited high discharge capacity, high charge/discharge efficiency, and a small precipitation amount of lithium metal.

Referring to Table 2, at a charge rate (SOC 120) of 120%, Comparative Example 2 exhibited low discharge capacity, very low charge and discharge efficiency, and a large precipitation amount of lithium metal, and Comparative Examples 1 and 3 each exhibited relatively low discharge capacity and charge/discharge efficiency and also, a relatively large precipitation amount of lithium metal. In contrast, Example 1 exhibited improved discharge capacity and charge/discharge efficiency and a reduced precipitation amount of lithium metal and thus improved characteristics in all the evaluations.

The use of “may” when describing embodiments of the inventive concept refers to “one or more embodiments of the inventive concept.”

As used herein, the term “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The rechargeable lithium battery and/or any other relevant control/management devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the [device] may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

While this disclosure has been described in connection with what is presently considered to be practical example embodiments, it is to be understood that the disclosure is not limited to the disclosed embodiments. In contrast, it is intended to cover one or more suitable modifications and equivalent arrangements included within the spirit and scope of the present disclosure as defined by the appended claims, and equivalents thereof.

### REFERENCE NUMERALS

10: negative electrode
12: current collector
14: first negative electrode active material layer
16: second negative electrode active material layer
20: positive electrode
30: separator
40: electrode assembly
50: case
100: rechargeable lithium battery

What is claimed is:

1. A negative electrode for a rechargeable lithium battery, the negative electrode comprising:
a current collector;
a first negative electrode active material layer on one surface or both surfaces of the current collector; and
a second negative electrode active material layer on the first negative electrode active material layer,
wherein the first negative electrode active material layer comprises a first negative electrode active material, and the first negative electrode active material comprises graphite comprising particles having a single particle shape,
the second negative electrode active material layer comprises a second negative electrode active material, and the second negative electrode active material comprises graphite comprising secondary particles in which a plurality of primary particles are agglomerated, and
an average particle diameter of the second negative electrode active material is smaller than an average particle diameter of the first negative electrode active material.

2. The negative electrode of claim 1, wherein in the first negative electrode active material, the particles having a single particle shape have an average particle diameter of greater than about 15 μm.

3. The negative electrode of claim 1, wherein in the second negative electrode active material, the secondary particles have an average particle diameter of less than or equal to about 15 μm.

4. The negative electrode of claim 1, wherein in the second negative electrode active material, the plurality of primary particles have an average particle diameter of about 1 μm to about 10 μm.

5. The negative electrode of claim 1, wherein a ratio of the average particle diameter of the secondary particles of the second negative electrode active material to the average particle diameter of the particles of the first negative electrode active material is about 0.1 to about 0.9.

6. The negative electrode of claim 1, wherein a specific surface area of the second negative electrode active material is smaller than a specific surface area of the first negative electrode active material.

7. The negative electrode of claim 1, wherein the first negative electrode active material has a specific surface area of greater than about 1.5 m²/g.

8. The negative electrode of claim 1, wherein the second negative electrode active material has a specific surface area of less than or equal to about 1.5 m²/g.

9. The negative electrode of claim 1, wherein a pellet density of the second negative electrode active material is smaller than a pellet density of the first negative electrode active material.

10. The negative electrode of claim 1, wherein the first negative electrode active material has a pellet density of greater than about 1.6 g/cc.

11. The negative electrode of claim 1, wherein the second negative electrode active material has a pellet density of less than or equal to about 1.6 g/cc.

12. The negative electrode of claim 1, wherein at least one of the first negative electrode active material or the second negative electrode active material is coated with amorphous carbon.

13. The negative electrode of claim 1, wherein in the negative electrode, a weight ratio of the first negative electrode active material to the second negative electrode active material is about 10:90 to about 50:50.

14. The negative electrode of claim 1, wherein a ratio of the thickness of the first negative electrode active material layer to the thickness of the second negative electrode active material layer is about 10:90 to about 40:60.

15. A rechargeable lithium battery comprising the negative electrode of claim 1.
